(19) United States
(12) Patent Application Publication
(10) Pub. No.: US 2017/0284071 A1
(43) Pub. Date: Oct. 5, 2017

(54) CALIBRATION SYSTEM, WORK MACHINE, AND CALIBRATION METHOD

(71) Applicant: Komatsu Ltd., Tokyo (JP)

(72) Inventors: Hiroyoshi Yamaguchi, Kanagawa (JP); Shogo Atsumi, Kanagawa (JP); Shun Kawamoto, Kanagawa (JP); Taiki Sugawara, Kanagawa (JP)

(73) Assignee: Komatsu Ltd., Tokyo (JP)

(21) Appl. No.: 15/308,453

(22) PCT Filed: Mar. 29, 2016
(86) PCT No.: PCT/JP2016/060273

§ 371 Date: Nov. 2, 2016

(51) Int. Cl. E02F 9/26; G06T 7/80; E02F 3/32; G06T 7/00; B60R 11/04; E02F 9/22

(52) U.S. Cl. CPC E02F 9/265; B60R 11/04; E02F 9/2203; E02F 9/262; E02F 3/32; G06T 7/97; G06T 7/80

(57) ABSTRACT

A calibration system includes at least a pair of imaging devices in a work machine having a working unit that image an object; a position detector detecting a position of the working unit; and a processing unit that, by using first position information about a predetermined position of the working unit captured by the imaging devices, second position information about the predetermined position detected by the position detector in an attitude of the working unit taken when the imaging devices image the predetermined position, and third position information about a predetermined position outside the work machine, imaged by the imaging devices, obtains information about a position and an attitude of the imaging devices, and transformation information used for transforming a position of the object imaged by the imaging devices from a first coordinate system to a second coordinate system.

### FIELD

The present invention relates to a calibration system for calibrating a position detection unit of a work machine detecting a position of an object, and further relates to a work machine and a calibration method.

### BACKGROUND

There is a work machine including an imaging device used for stereoscopic three-dimensional measurement, as a device for detecting a position of an object (e.g., Patent Literature 1).

### CITATION LIST

### Patent Literature

Patent Literature 1: Japanese Patent Application Laid-open No. 2012-233353

### SUMMARY

### Technical Problem

The imaging device used for the stereoscopic three-dimensional measurement needs to be calibrated. In the work machine including the imaging device, the imaging device is subjected to calibration for example before shipment from a factory, but since devices and facilities are required for the calibration, and the calibration of the imaging device may be difficult in a site on which the work machine works.

An object of an aspect of the present invention is to achieve calibration of an imaging device even in a site on which a work machine including an imaging device for performing stereoscopic three-dimensional measurement works.

### Solution to Problem

According to a first aspect of the present invention, a calibration system comprises: at least a pair of imaging devices included in a work machine having a working unit that image an object; a position detection device that detects a position of the working unit; and a processing unit that, by using first position information being information about a predetermined position of the working unit captured by at least the pair of the imaging devices, second position information being information about the predetermined position detected by the position detection device in an attitude of the working unit taken when at least the pair of the imaging devices image the predetermined position, and third position information being information about a predetermined position outside the work machine, imaged by at least the pair of the imaging devices, obtains information about a position and an attitude of at least the pair of the imaging devices, and transformation information used for transforming a position of the object imaged by at least the pair of the imaging devices from a first coordinate system to a second coordinate system.

According to a second aspect of the present invention, a work machine comprises: the working unit; and the calibration system according to the first aspect.

According to a third aspect of the present invention, a calibration method comprises: a detection step of imaging a predetermined position of a working unit and a predetermined position around a work machine having the working unit by at least a pair of imaging devices, and detecting a predetermined position of the work machine by a position detection device different from at least the pair of the imaging devices; and a calculation step of obtaining information about a position and an attitude of at least the pair of the imaging devices, and transformation information used for transforming a position of the object detected by at least the pair of the imaging devices from a first coordinate system to a second coordinate system, by using first position information being information about a predetermined position of the working unit captured by at least the pair of the imaging devices, second position information being information about the predetermined position detected by the position detection device in an attitude of the working unit taken when at least the pair of the imaging devices image the predetermined position, and third position information being information about a predetermined position outside the work machine, imaged by at least the pair of the imaging devices.

According to the present invention, transformation information can be determined which transforms position information of an object detected by a device of a work machine for detecting a position of an object, to a coordinate system other than that of the device for detecting the position of the object.

According to an aspect of the present invention, the work machine including an imaging device for performing stereoscopic three-dimensional measurement can achieve calibration of the imaging device, even in a site on which the work machine works.

### BRIEF DESCRIPTION OF DRAWINGS

FIG. 1 is a perspective view of an excavator including a calibration system according to an embodiment.

FIG. 2 is a perspective view of a portion around a driver's seat of an excavator according to an embodiment.

FIG. 3 is a diagram illustrating a size of a working unit of an excavator according to an embodiment, and a coordinate system of the excavator.

FIG. 4 is a diagram illustrating a calibration system according to an embodiment.

FIG. 5 is a diagram illustrating objects to be imaged by imaging devices, upon performance of a calibration method according to an embodiment by a processing device according to an embodiment.

FIG. 6 is a diagram illustrating an exemplary image of targets captured by imaging devices.

FIG. 7 is a perspective view illustrating positions where targets mounted to teeth of a bucket are imaged by imaging devices.

FIG. 8 is a perspective view illustrating positions where targets placed outside an excavator are imaged by an imaging device.

FIG. 9 is a flowchart illustrating an exemplary process of a calibration method according to an embodiment performed by a processing device 20 according to an embodiment.

FIG. 10 is a diagram illustrating another example of a target for obtaining third position information.

FIG. 11 is a diagram illustrating a place where at least a pair of imaging devices is calibrated.

FIG. 12 is a diagram illustrating an example of a tool used for placing a target outside an excavator.

### DESCRIPTION OF EMBODIMENTS

A mode for carrying out the present invention (embodiment) will be described below in detail with reference to the drawings.

<Overall Configuration of Excavator>

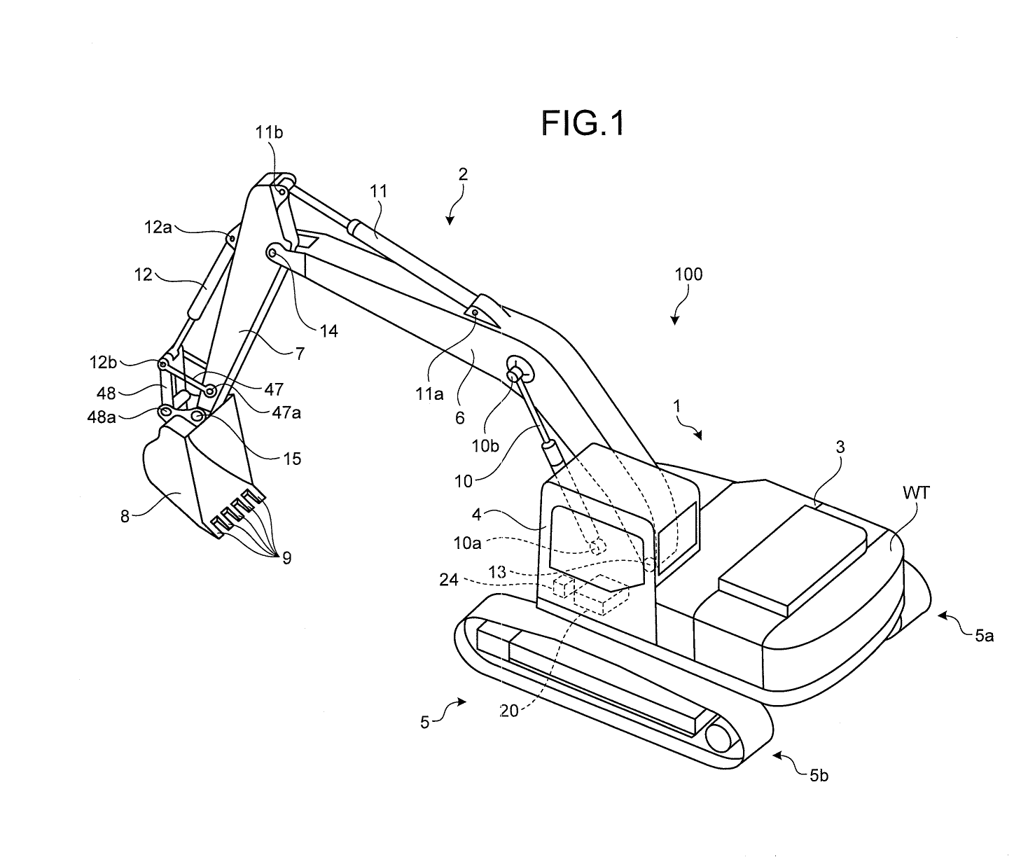

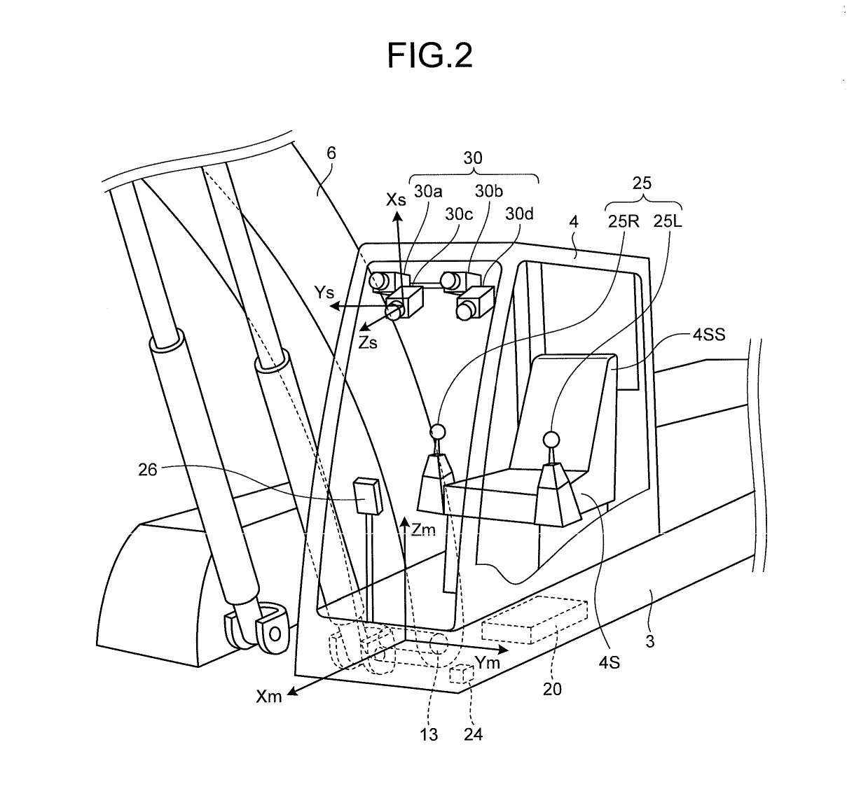

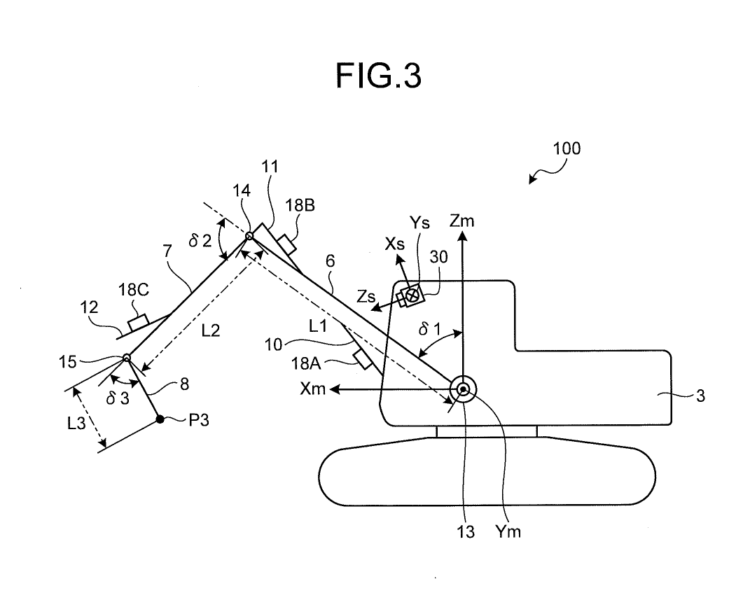

FIG. 1 is a perspective view of an excavator 100 including a calibration system according to an embodiment. FIG. 2 is a perspective view of a portion around a driver's seat of the excavator 100 according to an embodiment. FIG. 3 is a diagram illustrating a size of a working unit 2 of the excavator according to an embodiment, and a coordinate system of the excavator 100.

The excavator 100 as a work machine has a vehicle body 1 and the working unit 2. The vehicle body 1 has a swing body 3, a cab 4, and a travel body 5. The swing body 3 is swingably mounted to the travel body 5. The cab 4 is disposed at a front portion of the swing body 3. An operation device 25 illustrated in FIG. 2 is disposed in the cab 4. The travel body 5 has track belts 5a and 5b, and the track belts 5a and 5b are turned to cause the excavator 100 to travel.

The working unit 2 is mounted to a front portion of the vehicle body 1. The working unit 2 has a boom 6, an arm 7, a bucket 8 as a working implement, a boom cylinder 10, an arm cylinder 11, and a bucket cylinder 12. In the embodiment, a front side of the vehicle body 1 is positioned in a direction from a backrest 4SS of a driver's seat 4S to the operation device 25 illustrated in FIG. 2. A rear side of the vehicle body 1 is positioned in a direction from the operation device 25 to the backrest 4SS of the driver's seat 4S. A front portion of the vehicle body 1 is a portion on a front side of the vehicle body 1, and is a portion on the opposite side to a counter weight WT of the vehicle body 1. The operation device 25 is a device for operating the working unit 2 and the swing body 3, and has a right lever 25R and a left lever 25L. In the cab 4, a monitor panel 26 is provided in front of the driver's seat 4S.

The boom 6 has a base end portion mounted to the front portion of the vehicle body 1 through a boom pin 13. The boom pin 13 corresponds to a center of motion of the boom 6 relative to the swing body 3. The arm 7 has a base end portion mounted to an end portion of the boom 6 through an arm pin 14. The arm pin 14 corresponds to a center of motion of the arm 7 relative to the boom 6. The arm 7 has an end portion to which the bucket 8 is mounted through a bucket pin 15. The bucket pin 15 corresponds to a center of motion of the bucket 8 relative to the arm 7.

As illustrated in FIG. 3, the length of the boom 6, that is, the length between the boom pin 13 and the arm pin 14 is denoted by L1. The length of the arm 7, that is, the length between the arm pin 14 and the bucket pin 15 is denoted by L2. The length of the bucket 8, that is, the length between the bucket pin 15 and a tooth tip P3 of a tooth 9 of the bucket 8 is denoted by L3.

Each of the boom cylinder 10, the arm cylinder 11, and the bucket cylinder 12 illustrated in FIG. 1 is a hydraulic cylinder driven by hydraulic pressure. The cylinders are an actuator provided at the vehicle body 1 of the excavator 100 to actuate the working unit 2. The boom cylinder 10 has a base end portion mounted to the swing body 3 through a boom cylinder foot pin 10a. The boom cylinder 10 has an end portion mounted to the boom 6 through a boom cylinder top pin 10b. The boom cylinder 10 is expanded and contracted by hydraulic pressure to actuate the boom 6.

The arm cylinder 11 has a base end portion mounted to the boom 6 through an arm cylinder foot pin 11a. The arm cylinder 11 has an end portion mounted to the arm 7 through an arm cylinder top pin 11b. The arm cylinder 11 is expanded and contracted by hydraulic pressure to actuate the arm 7.

The bucket cylinder 12 has a base end portion mounted to the arm 7 through a bucket cylinder foot pin 12a. The bucket cylinder 12 has an end portion mounted to one end of a first link member 47 and one end of a second link member 48 through a bucket cylinder top pin 12b. The other end of the first link member 47 is mounted to the end portion of the arm 7 through a first link pin 47a. The other end of the second link member 48 is mounted to the bucket 8 through a second link pin 48a. The bucket cylinder 12 is expanded and contracted by hydraulic pressure to actuate the bucket 8.

As illustrated in FIG. 3, the boom cylinder 10, the arm cylinder 11, and the bucket cylinder 12 are provided with a first angle detection unit 18A, a second angle detection unit 18B, and a third angle detection unit 18C, respectively. The first angle detection unit 18A, the second angle detection unit 18B, and the third angle detection unit 18C are for example a stroke sensor. The angle detection units detect stroke lengths of the boom cylinder 10, the arm cylinder 11, and the bucket cylinder 12, respectively, to indirectly detect an angle of movement of the boom 6 relative to the vehicle body 1, an angle of movement of the arm 7 relative to the boom 6, and an angle of movement of the bucket 8 relative to the arm 7.

In the embodiment, the first angle detection unit 18A detects an amount of movement of the boom cylinder 10, that is, the stroke length thereof. A processing device 20 described later calculates the angle 61 of movement of the boom 6 relative to a Zm axis of the coordinate system (Xm, Ym, Zm) of the excavator 100 illustrated in FIG. 3, based on the stroke length of the boom cylinder 10 detected by the first angle detection unit 18A. Hereinafter, the coordinate system of the excavator 100 will be appropriately referred to as vehicle body coordinate system. As illustrated in FIG. 2, the origin of the vehicle body coordinate system is positioned at the center of the boom pin 13. The center of the boom pin 13 represents the center of a cross-section of the boom pin 13 which is taken along a plane orthogonal to a direction in which the boom pin 13 extends, and the center in the direction in which the boom pin 13 extends. The vehicle body coordinate system is not limited to an example of the embodiment, and for example, the center of swing of the swing body 3 may be defined as a Zm axis, an axis parallel with a direction in which the boom pin 13 extends as a Ym axis, and an axis orthogonal to the Zm axis and the Ym axis as an Xm axis.

The second angle detection unit 18B detects an amount of movement of the arm cylinder 11, that is, the stroke length thereof. The processing device 20 calculates the angle δ2 of movement of the arm 7 relative to the boom 6, based on the stroke length of the arm cylinder 11 detected by the second angle detection unit 18B. The third angle detection unit 18C detects an amount of movement of the bucket cylinder 12, that is, the stroke length thereof. The processing device 20 calculates the angle δ3 of movement of the bucket 8 relative to the arm 7, based on the stroke length of the bucket cylinder 12 detected by the third angle detection unit 180.

<Imaging Device>

As illustrated in FIG. 2, the excavator 100 has for example a plurality of imaging devices 30a, 30b, 30c, and 30d in the cab 4. Hereinafter, when the plurality of imaging devices 30a, 30b, 30c, and 30d are not distinguished from each other, the imaging devices will be appropriately referred to as imaging device 30. The type of the imaging device 30 is not limited, but in the embodiment, for example, an imaging device including a couple charged device (CCD) image sensor or a complementary metal oxide semiconductor (CMOS) image sensor is employed.

In the embodiment, the plurality of, in particular, four imaging devices 30a, 30b, 30c, and 30d are mounted to the excavator 100. More specifically, as illustrated in FIG. 2, the imaging device 30a and the imaging device 30b are disposed at a predetermined interval to be oriented in the same direction, for example in the cab 4. The imaging device 30c and the imaging device 30d are disposed at a predetermined interval to be oriented in the same direction, in the cab 4. The imaging device 30b and the imaging device 30d may be disposed to be directed slightly toward the working unit 2, that is, slightly toward the imaging device 30a and the imaging device 30c. In the plurality of imaging devices 30a, 30b, 30c, and 30d, two of them are combined to constitute a stereo camera. In the embodiment, a combination of the imaging devices 30a and 30b and a combination of the imaging devices 30c and 30d constitute stereo cameras, respectively.

In the embodiment, the excavator 100 has four imaging devices 30, but the number of imaging devices 30 of the excavator 100 is preferably at least two, that is, a pair of imaging devices 30, and is not limited to four. It is because the excavator 100 constitutes the stereo camera using at least a pair of the imaging devices 30 to capture stereoscopic images of the object.

The plurality of imaging devices 30a, 30b, 30c, and 30d is disposed on the front side and upper side of the cab 4. The upper side is positioned in a direction orthogonal to a contact area of the track belts 5a and 5b of the excavator 100, and away from the contact area. The contact area of the track belts 5a and 5b represents a portion of at least one of the track belts 5a and 5b making contact with the ground, and a plane defined by at least three non-collinear points in the portion. The plurality of imaging devices 30a, 30b, 30c, and 30d captures the stereoscopic images of the object positioned in front of the vehicle body 1 of the excavator 100. The object is for example an object to be excavated by the working unit 2.

The processing device 20 illustrated in FIGS. 1 and 2 uses the stereoscopic images captured by at least a pair of the imaging devices 30 to three-dimensionally measure the object. That is, the processing device 20 performs stereoscopic image processing on the images of the same object captured by at least a pair of the imaging devices 30 to three-dimensionally measure the object described above. Places where the plurality of imaging devices 30a, 30b, 30c, and 30d are disposed are not limited to the front side and upper side of the cab 4.

In the embodiment, the imaging device 30c of the plurality of four imaging devices 30a, 30b, 30c, and 30d is used as a reference of the plurality of four imaging devices 30a, 30b, 30c, and 30d. A coordinate system (Xs, Ys, Zs) of the imaging device 30c is appropriately referred to as an imaging device coordinate system. The origin of the imaging device coordinate system is positioned at the center of the imaging device 30c. The origins of respective coordinate systems of the imaging device 30a, the imaging device 30b, and the imaging device 30d are positioned at the center of respective imaging devices.

<Calibration System>

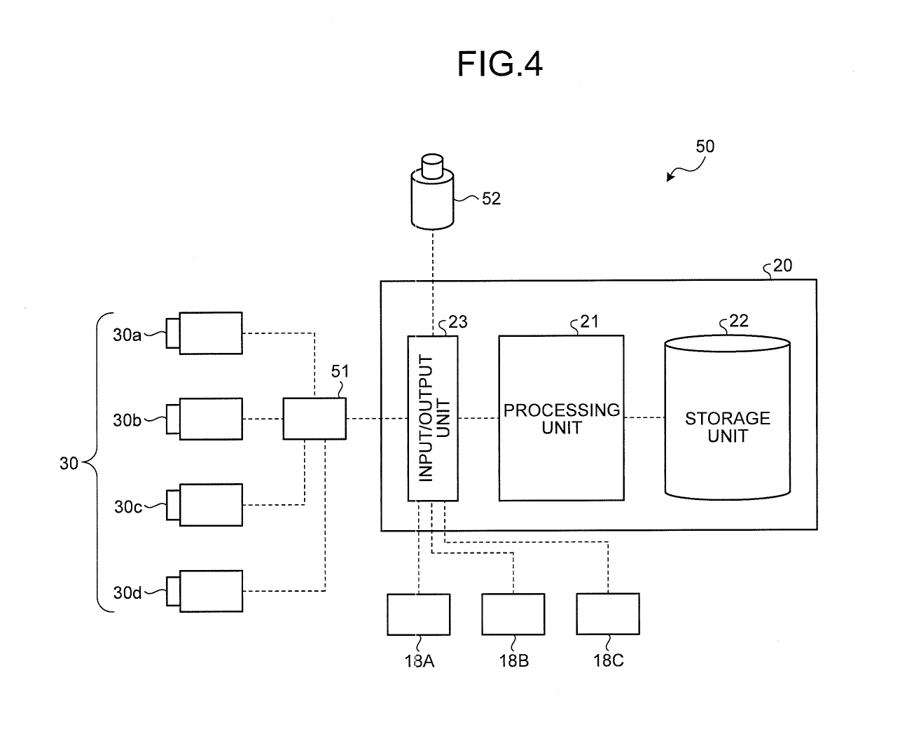

FIG. 4 is a diagram illustrating a calibration system 50 according to an embodiment. The calibration system 50 includes the plurality of imaging devices 30a, 30b, 30c, and 30d, and the processing device 20. As illustrated in FIGS. 1 and 2, the plurality of imaging devices 30a, 30b, 30c, and 30d, and the processing device 20 are provided in the vehicle body 1 of the excavator 100. The plurality of imaging devices 30a, 30b, 30c, and 30d are mounted to the excavator 100 as the work machine to image the object and output the image of the object obtained by the imaging to the processing device 20.

The processing device 20 has a processing unit 21, a storage unit 22, and an input/output unit 23. The processing unit 21 is achieved for example by a processor such as a central processing unit (CPU), and a memory. The processing device 20 achieves a calibration method according to an embodiment. In this configuration, the processing unit 21 reads and executes a computer program stored in the storage unit 22. This computer program causes the processing unit 21 to perform the calibration method according to an embodiment.

When performing the calibration method according to an embodiment, the processing device 20 performs the stereoscopic image processing on a pair of images captured by at least a pair of the imaging devices 30 to find a position of the object, specifically, coordinates of the object in a three-dimensional coordinate system. As described above, the processing device 20 can use a pair of the images obtained by imaging the same object by at least a pair of the imaging devices 30 to three-dimensionally measure the object. That is, at least a pair of the imaging devices 30 and the processing device 20 perform stereoscopic three-dimensional measurement on the object.

In the embodiment, at least a pair of the imaging devices 30 and the processing device 20 are provided in the excavator 100, and correspond to a first position detection unit for detecting the position of the object. When the imaging device 30 has a function of performing stereoscopic image processing to perform three-dimensional measurement on the object, at least a pair of the imaging devices 30 corresponds to the first position detection unit.

The storage unit 22 employs at least one of a non-volatile or volatile semiconductor memory, such as a random access memory (RAM), a read only memory (ROM), a flash memory, an erasable programmable read only memory (EPROM), or an electrically erasable programmable read only memory (EEPROM), a magnetic disk, a flexible disk, and a magnetooptical disk. The storage unit 22 stores the computer program for causing the processing unit 21 to perform the calibration method according to an embodiment.

The storage unit 22 stores information used in performance of the calibration method according to an embodiment by the processing unit 21. This information includes for example, attitude of each imaging device 30, a positional relationship between the imaging devices 30, a known size of the working unit 2 or the like, a known size indicating a positional relationship between the imaging device 30 and a fixed object mounted to the excavator 100, a known size indicating a positional relationship between the origin of the vehicle body coordinate system and each or any imaging device 30, and information required to determine a partial position of the working unit 2 based on an attitude of the working unit 2.

The input/output unit 23 is an interface circuit for connecting the processing device 20 and devices. To the input/output unit 23, a hub 51, an input device 52, the first angle detection unit 18A, the second angle detection unit 18B, and the third angle detection unit 18C are connected. To the hub 51, the plurality of imaging devices 30a, 30b, 30c, and 30d are connected. The imaging device 30 and the processing device 20 may be connected without using the hub 51. Results of imaging by the imaging devices 30a, 30b, 30c, and 30d are input to the input/output unit 23 through the hub 51. The processing unit 21 obtains the results of imaging by the imaging devices 30a, 30b, 30c, and 30d through the hub 51 and the input/output unit 23. The input device 52 is used to give the input/output unit 23 information required to perform the calibration method according to an embodiment by the processing unit 21.

The input device 52 is exemplified by for example a switch or a touch panel, but is not limited to them. In the embodiment, the input device 52 is provided in the cab 4 illustrated in FIG. 2, more specifically, in the vicinity of the driver's seat 4S. The input device 52 may be mounted to at least one of the right lever 25R and the left lever 25L of the operation device 25, and may be provided at the monitor panel 26 in the cab 4. Furthermore, the input device 52 may be removable from the input/output unit 23, or information may be given to the input/output unit 23 by wireless communication using a radio wave or infrared light

The processing device 20 may be achieved using dedicated hardware, or the function of the processing device 20 may be achieved by a plurality of processing circuits cooperating with each other.

A predetermined position of the working unit 2 in the vehicle body coordinate system (Xm, Ym, Zm) can be determined based on a size of each portion of the working unit 2, and the angles δ1, δ2, and δ3 of movement of the working unit 2. The angles δ1, δ2, and δ3 of movement are information detected by the first angle detection unit 18A, the second angle detection unit 18B, and the third angle detection unit 18C. The predetermined position of the working unit 2 determined based on the size of the working unit 2 and the angles δ1, δ2, and δ3 of movement includes for example a position of a tooth 9 of the bucket 8 of the working unit 2, a position of the bucket pin 15, or a position of the first link pin 47a. The first angle detection unit 18A, the second angle detection unit 18B, and the third angle detection unit 18C correspond to a position detection device for detecting a position of the excavator 100 as a work machine according to an embodiment, for example, a position of the working unit 2.

When at least a pair of the imaging devices 30 are calibrated, a predetermined position of the excavator 100 detected by the position detection device is the same as the predetermined position of the working unit 2 being the object to be imaged by at least a pair of the imaging devices 30. In the embodiment, the predetermined position of the excavator 100 detected by the position detection device is located at the predetermined position of the working unit 2, but the predetermined position of the excavator 100 is not limited to the predetermined position of the working unit 2, as long as the predetermined position of the excavator 100 is located at a predetermined position of an element constituting the excavator 100.

<Calibration of Imaging Device 30>

In the embodiment, a combination of a pair of imaging devices 30a and 30b and a combination of a pair of imaging devices 30c and 30d illustrated in FIG. 2 constitute the stereo cameras, respectively. The imaging devices 30a, 30b, 30c, and 30d of the excavator 100 are subjected to external calibration and vehicle calibration, before the excavator 100 is used for actual work. The external calibration represents operation for determining positions and attitudes of a pair of imaging devices 30. Specifically, the external calibration determines positions and attitudes of a pair of the imaging devices 30a and 30b, and positions and attitudes of a pair of the imaging devices 30c and 30d. When the above-mentioned information is not obtained, the stereoscopic three-dimensional measurement cannot be achieved.

A relationship between the positions and the attitudes of a pair of the imaging devices 30a and 30b can be obtained by formula (1), and a relationship between the positions and the attitudes of a pair of the imaging devices 30c and 30d can be obtained by formula (2). Pa represents a position of the imaging device 30a, Pb represents a position of the imaging device 30b, Pc represents a position of the imaging device 30c, and Pd represents a position of the imaging device 30d. R1 represents a rotation matrix for transforming a position Pb to a position Pa, and R2 represents a rotation matrix for transforming a position Pd to a position Pc. T1 represents a translation matrix for transforming the position Pb to the position Pa, and R2 represents a translation matrix for transforming the position Pd to the position Pc.

Pa=R1·Pb+T1 (1)

Pc=R2·Pd+T2 (2)

The vehicle calibration represents operation for determining positional relationships between the imaging devices 30 and the vehicle body 1 of the excavator 100. The vehicle calibration is also referred to as internal calibration. In the vehicle calibration according to an embodiment, a positional relationship between the imaging device 30a and the vehicle body 1 and a positional relationship between the imaging device 30c and the vehicle body 1 are determined. When these positional relationships are not obtained, results of the stereoscopic three-dimensional measurement cannot be transformed to a site coordinate system.

The positional relationship between the imaging device 30a and the vehicle body 1 can be obtained by formula (3), a positional relationship between the imaging device 30b and the vehicle body 1 can be obtained by formula (4), the positional relationship between the imaging device 30c and the vehicle body 1 can be obtained by formula (5), and a positional relationship between the imaging device 30d and the vehicle body 1 can be obtained by formula (6). Pma represents a position of the imaging device 30a in the vehicle body coordinate system, Pmb represents a position of the imaging device 30b in the vehicle body coordinate system, Pmc represents a position of the imaging device 30c in the vehicle body coordinate system, and Pmd represents a position of the imaging device 30d in the vehicle body coordinate system. R3 is a rotation matrix for transforming the position Pa to a position in the vehicle body coordinate system, R4 is a rotation matrix for transforming the position Pb to a position in the vehicle body coordinate system, R5 is a rotation matrix for transforming the position Pc to a position in the vehicle body coordinate system, and R6 is a rotation matrix for transforming the position Pd to a position in the vehicle body coordinate system. T3 is a translation matrix for transforming the position Pa to a position in the vehicle body coordinate system, T4 is a translation matrix for transforming the position Pb to a position in the vehicle body coordinate system, T5 is a translation matrix for transforming the position Pc to a position in the vehicle body coordinate system, and T6 is a translation matrix for transforming the position Pd to a position in the vehicle body coordinate system.

Pma=R3·Pa+T3 (3)

Pmb=R4·Pb+T4 (4)

Pmc=R5·Pc+T5 (5)

Pmd=R6·Pd+T6 (6)

The processing device 20 determines the rotation matrices R3, R4, R5, and R6 and the translation matrices T3, T4, T5, and T6. When the matrices are determined, the positions Pa, Pb, Pc, and Pd of the imaging devices 30a, 30b, 30c, and 30d are transformed to the positions Pma, Pmb, Pmc, and Pmd in the vehicle body coordinate system. The rotation matrices R3, R4, R5, and R6 include a rotation angle α about the Xm axis, a rotation angle β about the Ym axis, and a rotation angle γ about the Zm axis in the vehicle body coordinate system (Xm, Ym, Zm) in illustrated in FIG. 2. The translation matrices T3, T4, T5, and T6 include a magnitude xm in an Xm direction, a magnitude ym in a Ym direction, and a magnitude zm in a Zm direction.

The magnitudes xm, ym, and zm being elements of the translation matrix T3 represent the position of the imaging device 30a in the vehicle body coordinate system. The magnitudes xm, ym, and zm being elements of the translation matrix T4 represent the position of the imaging device 30b in the vehicle body coordinate system. The magnitudes xm, ym, and zm being elements of the translation matrix T5 represent the position of the imaging device 30c in the vehicle body coordinate system. The magnitudes xm, ym, and zm being elements of the translation matrix T6 represent the position of the imaging device 30d in the vehicle body coordinate system.

The rotation angles α, β, and γ included in the rotation matrix R3 represent the attitude of the imaging device 30a in the vehicle body coordinate system. The rotation angles α, β, and γ included in the rotation matrix R4 represent the attitude of the imaging device 30b in the vehicle body coordinate system. The rotation angles α, β, and γ included in the rotation matrix R5 represent the attitude of the imaging device 30c in the vehicle body coordinate system. The rotation angles α, β, and γ included in the rotation matrix R6 represent the attitude of the imaging device 30d in the vehicle body coordinate system.

The excavator 100 is subjected to for example the external calibration and the vehicle calibration before shipment from the factory. Results of the calibrations are stored in the storage unit 22 of the processing device 20 illustrated in FIG. 4. In shipment from the factory, the external calibration is performed using a scaffold and a measurement instrument called total station as a calibration instrument, which are dedicated facilities, for example installed in a factory building. The scaffold is a large structure having a width of approximately several meters and a height of approximately several ten meters, and calibrated by a steel frame member or the like. When positional displacement of an imaging device 30 is generated or an imaging device 30 is replaced, in a site on which the excavator 100 works, the external calibration of the imaging device 30 is required. In the site on which the excavator works, it is difficult to prepare the scaffold and the total station to perform the external calibration.

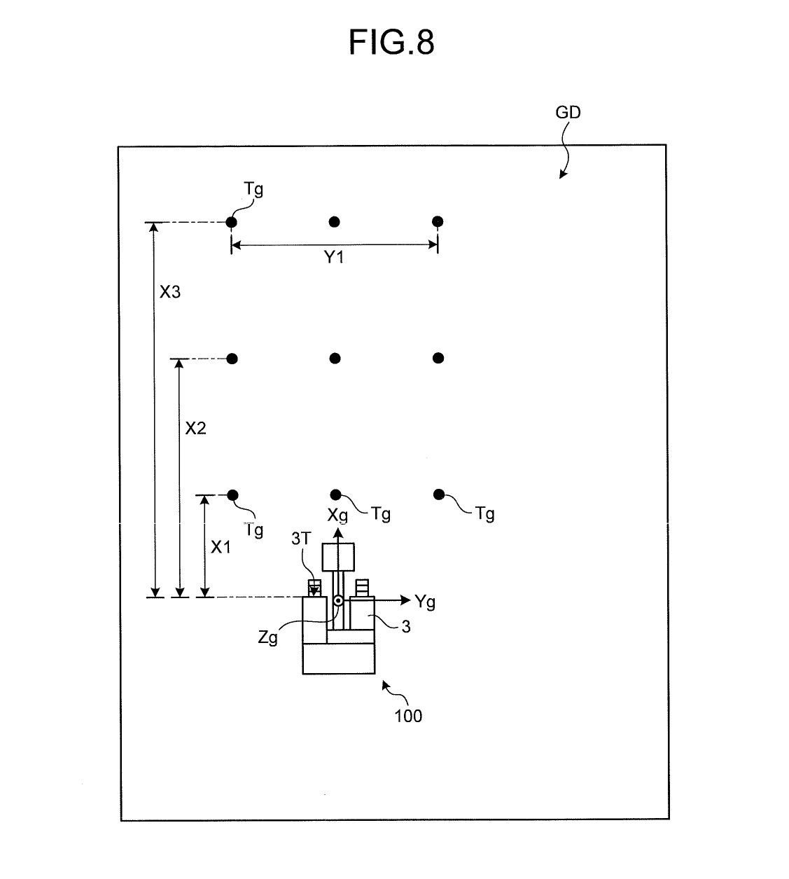

The calibration system 50 achieves the calibration method according to an embodiment to achieve the external calibration and the vehicle calibration of the imaging device 30 in the site on which the excavator 100 works. Specifically, the calibration system 50 uses the predetermined position of the working unit 2, the position of the tooth 9 of the bucket 8 in the embodiment. The calibration system 50 uses a plurality of positions of the teeth 9 of the bucket 8 obtained from the working unit 2 in different attitudes, and a predetermined position outside the excavator 100 to achieve both of the external calibration and the vehicle calibration. The predetermined position outside the excavator 100 will be described later in detail using FIG. 8 or the like.

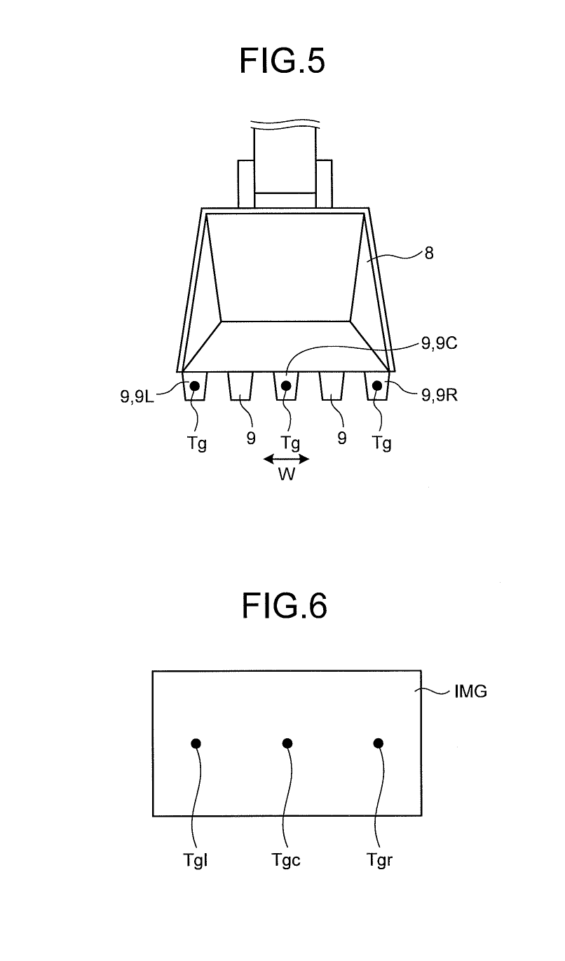

FIG. 5 is a diagram illustrating the objects to be imaged by the imaging devices 30, upon performance of the calibration method according to an embodiment by the processing device 20 according to an embodiment. When calibrating the imaging device 30, the calibration system 50 uses a position of a target Tg mounted to a tooth 9 of the bucket 8, as the predetermined position of the working unit 2. The target Tg is a first indicator disposed at a predetermined position of the working unit 2. The targets Tg are mounted to for example teeth 9L, 9C, and 9R. When viewing the bucket 8 from the cab 4, the tooth 9L is disposed at a left end, the tooth 9L at a right end, and the tooth 9C at the center. Note that, in the embodiment, description is made using the bucket 8 including the teeth 9, but the excavator 100 may include a bucket of another mode for example called slope finishing bucket including no tooth 9.

The targets Tg are used for the calibration of at least a pair of the imaging devices 30, and thus, the predetermined position of the working unit 2 and the predetermined position outside the excavator 100 are accurately detected. In the embodiment, the targets Tg are represented by white with a black dot. Such a target enhances contrast, and the predetermined position of the working unit 2 and the predetermined position outside the excavator 100 are further accurately detected.

In the embodiment, the targets Tg are aligned in a width direction W of the bucket 8, that is, in a direction parallel with a direction in which the bucket pin 15 extends. In the embodiment, the width direction W of the bucket 8 represents a direction in which at least one of a pair of the imaging devices 30a and 30b and a pair of the imaging devices 30c and 30d is disposed. In the embodiment, a pair of the imaging devices 30a and 30b and a pair of the imaging devices 30c and 30d are disposed in the same direction. A center tooth 9 in the width direction W of the bucket 8 moves only on one plane in the vehicle body coordinate system, that is, only on an Xm-Zm plane. A position of the center tooth 9 is unlikely to be affected by change in attitude in the width direction W of the bucket 8, and has high accuracy in position.

In the embodiment, the bucket 8 is provided with the targets Tg on the three teeth 9, but the number of targets Tg, that is, the number of teeth 9 being objects to be measured is not limited to three. The target Tg may be provided at least at one tooth 9. However, to inhibit deterioration in precision of stereoscopic positional measurement using a pair of the imaging devices 30a and 30b and a pair of the imaging devices 30c and 30d, in the calibration method according to an embodiment, at least two targets Tg are preferably provided at separated positions in the width direction W of the bucket 8 to obtain high precision in measurement.

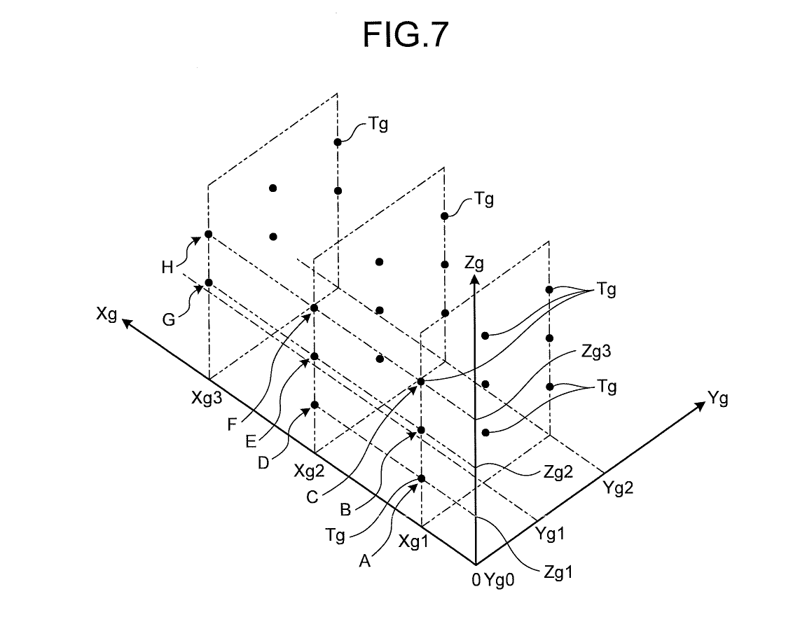

FIG. 6 is a diagram illustrating an exemplary image IMG of targets Tg captured by imaging devices 30a, 30b, 30c, and 30d. FIG. 7 is a perspective view illustrating positions where the targets Tg mounted to the teeth 9 of the bucket 8 are imaged by the imaging devices 30a, 30b, 30c, and 30d. FIG. 8 is a perspective view illustrating positions where targets Tg placed outside the excavator 100 are imaged by the imaging devices 30a, 30b, 30c, and 30d.

The targets Tg on the teeth 9 of the bucket 8 imaged by the imaging devices 30a, 30b, 30c, and 30d are represented as three targets Tgl, Tgc, and Tgr on the image IMG. The target Tgl is mounted to the tooth 9L. The target Tgc is mounted to the tooth 9C. The target Tgr is mounted to the tooth 9R.

When a pair of the imaging devices 30a and 30b constituting the stereo camera images the targets Tg, the images IMG are obtained from the imaging device 30a and the imaging device 30b, respectively. When a pair of the imaging devices 30c and 30d constituting the stereo camera images the targets Tg, the images IMG are obtained from the imaging device 30c and the imaging device 30d, respectively. Since the targets Tg are mounted to the teeth 9 of the bucket 8, the positions of the targets Tg represent the positions of the teeth 9 of the bucket 8, that is, represents the predetermined position of the working unit 2. Information about the positions of the targets Tg serves as first position information being information about the predetermined position of the working unit 2, imaged by at least a pair of the imaging devices 30. The information about the positions of the targets Tg is positional information in the image IMG, for example, information about positions of pixels constituting the image IMG.

The first position information is information obtained by imaging the positions of the targets Tg as the first indicators in the working unit 2 in different attitudes, by a pair of the imaging devices 30a and 30b and a pair of the imaging devices 30c and 30d. In the embodiment, a pair of the imaging devices 30a and 30b and a pair of the imaging devices 30c and 30d image the targets Tg at eight positions A, B, C, D, E, F, G, and H, as illustrated in FIG. 7.

In FIG. 7, the targets Tg are represented in an Xg-Yg-Zg coordinate system. An Xg axis is an axis parallel with the Xm axis of the vehicle body coordinate system of the excavator 100, and a front end of the swing body 3 of the excavator 100 is defined as 0. A Yg axis is an axis parallel with the Ym axis of the vehicle body coordinate system of the excavator 100. A Zg axis is an axis parallel with the Zm axis of the vehicle body coordinate system of the excavator 100. Positions Yg0, Yg1, and Yg2 of the targets Tg in a Yg axis direction correspond to the positions of the teeth 9L, 9C, and 9R of the bucket 8 to which the targets Tg are mounted. The position Yg1 in the Yg axis is a center position in the width direction W of the bucket 8.

The positions A, B, and C are located at a position Xg1 in an Xg axis direction, and located at Zg1, Zg2, and Zg3 in a Zg axis direction, respectively. The positions D, E, and F are located at a position Xg2 in the Xg axis direction, and located at Zg1, Zg2, and Zg3 in the Zg axis direction, respectively. The positions G and H are located at a position Xg3 in the Xg axis direction, and located at Zg2 and Zg3 in the Zg axis direction, respectively. The positions Xg1, Xg2, and Xg3 are away from the swing body 3 of the excavator 100, in this order.

In the embodiment, the processing device 20 determines positions of the tooth 9C, which is disposed at the center in the width direction W of the bucket 8, at the positions A, B, C, D, E, F, G, and H. Specifically, the processing device 20 obtains detection values of the first angle detection unit 18A, the second angle detection unit 18B, and the third angle detection unit 18C, at the positions A, B, C, D, E, F, G, and H, and determines the angles δ1, δ2, and δ3 of movement. The processing device 20 determines the position of the tooth 9C based on the determined angles δ1, δ2, and δ3 of movement and the lengths L1, L2, and L3 of the working unit 2. Thus obtained position of the tooth 9C represents a position Pm in the vehicle body coordinate system of the excavator 100. Information about positions of the tooth 9C in the vehicle body coordinate system, which are obtained at the positions A, B, C, D, E, F, G, and H, is second position information. The second position information represents information about the position of the tooth 9C as the predetermined position of the working unit 2, and the positions of the tooth 9C in the working unit 2 in different attitudes are detected by the first angle detection unit 18A, the second angle detection unit 18B, and the third angle detection unit 18C as the position detection device.

In the embodiment, as illustrated in FIG. 8, the targets Tg are placed at the predetermined positions outside the excavator 100. The targets Tg placed outside the excavator 100 are a second indicator. In the embodiment, the targets Tg are placed for example in the site on which the excavator 100 works. Specifically, the targets Tg are placed on the ground GD in front of the excavator 100. The targets Tg placed in front of the excavator 100 can reduce a time required for calibration of the imaging device 30 by the processing device 20, more specifically, reduce a time require for convergence of calculation of the calibration method according to an embodiment.

The targets Tg are arranged for example in a grid pattern in a first direction and a second direction perpendicular to the first direction. In the first direction, the targets Tg are placed at positions at distances X1, X2, and X3 from the front end 3T of the swing body 3 of the excavator 100. In the second direction, the three targets Tg are placed in a range of distance Y1. The magnitudes of the distances X1, X2, X3, and Y1 are not limited to specific values, but the targets Tg are preferably scattered within an imaging range of the imaging device 30. Furthermore, the distance X3 farthest from the swing body 3 is preferably larger than a maximum extended length of the working unit 2.

A pair of the imaging devices 30a and 30b and a pair of the imaging devices 30c and 30d image the targets Tg placed outside the excavator 100. The information about the positions of the targets Tg serves as third position information being information about the predetermined positions outside the excavator 100 imaged by at least a pair of the imaging devices 30. The information about the positions of the targets Tg is positional information in the images captured by a pair of the imaging devices 30a and 30b and a pair of the imaging devices 30c and 30d, for example, information about positions of pixels constituting the image.

A plurality of targets Tg placed outside the excavator 100 are preferably captured commonly by the imaging devices 30a, 30b, 30c, and 30d as much as possible. Furthermore, the targets Tg are preferably placed to face the imaging devices 30a, 30b, 30c, and 30d. Thus, the targets Tg may be mounted to bases set on the ground GD. In the calibration site, when an inclined surface gradually increased in height as separated from the excavator 100 is positioned in front of the excavator 100, the targets Tg may be placed on the inclined surface. Furthermore, in the calibration site, when there is a wall surface of a structure such as a building, the targets Tg may be mounted on the wall surface. In this configuration, the excavator 100 may be moved to a position in front of the wall surface on which the targets Tg are mounted When the targets Tg are placed as described above, the targets Tg face the imaging devices 30a, 30b, 30c, and 30d, and the imaging devices 30a, 30b, 30c, and 30d accurately image the targets Tg. In the embodiment, nine targets Tg are placed, but at least six targets Tg are preferably placed, and at least nine targets Tg are preferably placed.

The processing unit 21 of the processing device 20 uses the first position information, the second position information, and the third position information to determine information about the positions and the attitudes of a pair of the imaging devices 30a and 30b and a pair of the imaging devices 30c and 30d. The processing unit 21 determines transformation information used to transform the positions of the objects imaged by a pair of the imaging devices 30a and 30b and a pair of the imaging devices 30c and 30d, from a first coordinate system to a second coordinate system. The information about the positions of a pair of the imaging devices 30a and 30b and a pair of the imaging devices 30c and 30d (hereinafter appropriately referred to as position information) is magnitudes xm, ym, and zm included in translation matrices X3, X4, X5, and X6. The information about the attitudes of the a pair of the imaging devices 30a and 30b and a pair of the imaging devices 30c and 30d (hereinafter appropriately referred to as attitude information) is rotation angles α, β, and γ included in the rotation matrices R3, R4, R5, and R6. The transformation information is the rotation matrices R3, R4, R5, and R6.

The processing unit 21 uses bundle adjustment to process the first position information, the second position information, and the third position information, and determines the position information, the attitude information, and the transformation information. A process for determining the position information, the attitude information, and the transformation information, using the bundle adjustment is similar to a process of aerial photogrammetry.

The position of a target Tg illustrated in FIG. 5 in the vehicle body coordinate system are defined as Pm (Xm,Ym,Zm) or Pm. The position of a target Tg imaged by an imaging device 30 in the image IMG, illustrated in FIG. 6, are determined as Pg(i,j) or Pg. The position of a target Tg in the imaging device coordinate system is defined as Ps (Xs,Ys,Zs) or Ps. The positions of the targets Tg in the vehicle body coordinate system and the imaging device coordinate system are represented in three-dimensional coordinates, and the positions of the targets Tg in the image IMG are represented in two-dimensional coordinates.

A relationship between the position Ps of a target in the imaging device coordinate system and the position Pm of a target Tg in the vehicle body coordinate system is expressed by formula (7). R is the rotation matrix for transforming the position Pm to a position Ps, and T is the translation matrix for transforming a position Pm to a position Ps. Different rotation matrices R and translation matrices T are applied to the imaging devices 30a, 30b, 30c, and 30d. A relationship between the position Pg of a target Tg in the image IMG and the position Ps of a target in the imaging device coordinate system is expressed by formula (8). Formula (8) is a calculation formula for transforming the position Ps of a target in the three-dimensional imaging device coordinate system to the position Pg of a target Tg in the two-dimensional image IMG.

Ps=R·Pm+T (7)

(i−cx,j−cx)D=(Xs,Ys)/Zs (8)

D of formula (8) represents a pixel ratio (mm/pixel) where a focal distance is 1 mm. Furthermore, (cx,cy) are called image center, and represents a position of an intersection point between an optical axis of the imaging device 30 and the image IMG. D and cx, cy are determined by the internal calibration.

Formulas (9) to (11) can be obtained from the formulas (7) and (8) in terms of one target Tg imaged by one imaging device 30.

f(Xm,i,j;R,T)=0 (9)

f(Ym,i,j;R,T)=0 (10)

f(Zm,i,j;R,T)=0 (11)

The processing unit 21 creates as many formulas (9) to (11) as the number of targets Tg imaged by the imaging devices 30a, 30b, 30c, and 30d. The processing unit 21 substitutes values of the position Pm in the vehicle body coordinate system as known coordinates, for the position of the target Tg mounted to the center tooth 9 in the width direction W of the bucket 8. The processing unit 21 has unknown coordinates, for remaining targets Tg mounted to the teeth 9 of the bucket 8, that is, the positions of the targets Tg mounted to the teeth 9 positioned at both ends of the bucket 8. The processing unit 21 also has unknown coordinates for the positions of the targets Tg placed outside the excavator 100. The position of the target Tg mounted to the center tooth 9 in the width direction W of the bucket 8 correspond to a reference point in the aerial photogrammetry. The positions of the targets Tg mounted to the teeth 9 at both ends of the bucket 8 and the positions of the targets Tg placed outside the excavator 100 correspond to pass points in the aerial photogrammetry.

In the embodiment, when the number of targets Tg mounted to the center tooth 9 in the width direction W of the bucket 8 is eight, the number of targets Tg mounted to the teeth 9 positioned at both ends of the bucket 8 is 16, and the number of targets Tg used for calibration selected from the targets Tg placed outside the excavator 100 is five, formulas (9) to (11) are respectively obtained for a total of 29 targets Tg imaged by one imaging device 30. Since the calibration method according to an embodiment achieves stereo matching by at least a pair of imaging devices 30 using the external calibration, the processing unit 21 generates formulas (9) to (11) for the total of 29 targets Tg imaged by a pair of imaging devices 30, respectively. The processing unit 21 uses a least squares method to determine the rotation matrix R and the translation matrix T based on the obtained formulas.

The processing unit 21 solves the obtained formulas for example using a Newton-Raphson method to determine an unknown in the obtained formulas. At this time, the processing unit 21 uses, as initial values, for example results of the external calibration and the vehicle calibration performed before shipment of the excavator 100 from a factory. Furthermore, the processing unit 21 uses an estimate for a target Tg having unknown coordinates. For example, estimates for the positions of the targets Tg mounted to the teeth 9 at both ends of the bucket 8 can be obtained from the position of the target Tg mounted to the center tooth 9 in the width direction W of the bucket 8 and a dimension of the bucket 8 in the width direction W. Estimates for the positions of the targets Tg placed outside the excavator 100 are values measured from the origin of the vehicle body coordinate system of the excavator 100.

In the embodiment, for example the results of the external calibration and the vehicle calibration performed before shipment of the excavator 100 from the factory are stored in the storage unit 22 illustrated in FIG. 4. The estimates for the positions of the targets Tg placed outside the excavator 100 are previously determined by a worker performing calibration, for example, a service man or an operator of the excavator 100, and the estimates are stored in the storage unit 22. When determining the unknown in the obtained formulas, the processing unit 21 reads, from the storage unit 22, a result of the external calibration, a result of the vehicle calibration, and the estimates for the positions of the targets Tg placed outside the excavator 100, as initial values for solving the obtained formulas.

When the initial values are set, the processing unit 21 solves the obtained formulas. When calculation for solving the obtained formulas converges, the processing unit 21 defines the obtained values as the position information, the attitude information, and the transformation information. Specifically, upon convergence of the calculation, the magnitudes xm, ym, and zm and the rotation angles α, β, and γ are obtained for the imaging devices 30a, 30b, 30c, and 30d, and the magnitudes xm, ym, and zm and the rotation angles α, β, and γ are defined as the position information and the attitude information of the imaging devices 30a, 30b, 30c, and 30d. The transformation information is the rotation matrix R including the rotation angles α, β, and γ, and the translation matrix T having the magnitudes xm, ym, and zm as elements.

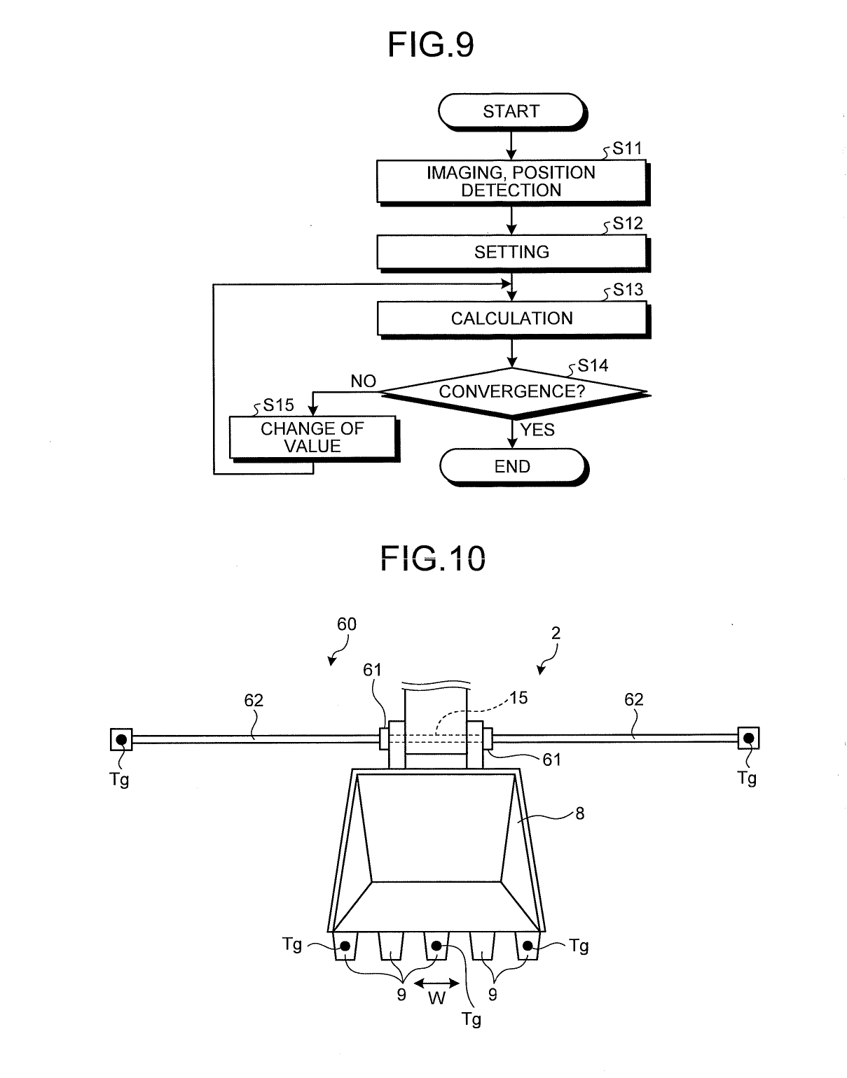

FIG. 9 is a flowchart illustrating an exemplary process of the calibration method according to an embodiment performed by the processing device 20 according to an embodiment. In step S11 as a detection step, the processing unit 21 of the processing device 20 causes a pair of the imaging devices 30a and 30b and a pair of the imaging devices 30c and 30d to image the plurality of targets Tg mounted to the teeth 9 of the bucket 8 in the working unit 2 in different attitudes. At this time, when the working unit 2 is in each attitude, the processing unit 21 obtains detection values from the first angle detection unit 18A, the second angle detection unit 18B, and the third angle detection unit 18C. Then, the processing unit 21 determines the position of the tooth 9C based on the obtained detection values. The processing unit 21 causes the storage unit 22 to temporarily store the determined position of the tooth 9C. The processing unit 21 causes a pair of the imaging devices 30a and 30b and a pair of the imaging devices 30c and 30d to image the targets Tg placed outside the excavator 100. The processing unit 21 determines the positions Pg of the targets Tg in the images IMG, which are imaged by the imaging devices 30a, 30b, 30c, and 30d, and causes the storage unit 22 to temporarily store the determined positions Pg.

The processing unit 21 uses the bundle adjustment to process the first position information, the second position information, and the third position information, and generates the plurality of formulas for determining the position information, the attitude information, and the transformation information. In step S12, the processing unit 21 sets an initial value. In step S13 as a calculation step, the processing unit 21 performs the bundle adjustment calculation. In step S14, the processing unit 21 performs determination of convergence in calculation.

When the processing unit 21 determines non convergence of the calculation (step S14, No), the process proceeds to step S15, and the processing unit 21 changes the initial value at the start of the bundle adjustment calculation, and performs calculation in step S13 and determination of the convergence in step S14. When the processing unit 21 determines convergence of the calculation (step S14, Yes), the calibration ends. At the end of the calibration, values obtained upon convergence of the calculation are defined as the position information, the attitude information, and the transformation information.

<Target Tg for Obtaining Third Position Information>

FIG. 10 is a diagram illustrating another example of a target Tg for obtaining third position information. As described above, a pair of the imaging devices 30a and 30b and a pair of the imaging devices 30c and 30d image the targets Tg mounted to the teeth 9 of the bucket 8 in the working unit 2 in different attitudes. In an example illustrated in FIG. 10, the targets Tg placed outside the excavator 100 are used to increase a rate of the targets Tg in the images captured by a pair of the imaging devices 30c and 30d mounted to be directed downward.

As described above, the rate of the targets Tg in the images captured by a pair of the imaging devices 30c and 30d is preferably increased, and thus the third position information is not limited to the information obtained from the targets Tg placed outside the excavator 100. For example, As illustrated in FIG. 10, the targets Tg may be disposed at positions to have a width larger than that of the bucket 8, using a mounting fixture 60.

The mounting fixture 60 has a shaft member 62 on which a target Tg is mounted, and a fixing member 61 mounted to one end of the shaft member 62. The fixing member 61 has a magnet. The fixing member 61 is attracted to the working unit 2 to mount for example the target Tg and the shaft member 62 to the working unit 2. As described above, the fixing member 61 can be mounted to the working unit 2 and removed from the working unit 2. In this example, the fixing member 61 is attracted to the bucket pin 15 to fix the target Tg and the shaft member 62 to the working unit 2. When the target Tg is mounted to the working unit 2, the mounted target Tg is disposed outside a target Tg mounted to a tooth 9 of the bucket 8, in the width direction W of the bucket 8.

In the external calibration and the vehicle calibration, the processing unit 21 causes a pair of the imaging devices 30a and 30b and a pair of the imaging devices 30c and 30d to image the targets Tg mounted to the working unit 2 using the mounting fixture 60 and the targets Tg mounted to the teeth 9 of the bucket 8 in the working unit 2 in different attitudes. Imaging the targets Tg mounted to the working unit 2 using the mounting fixture 60 maintains the rate of the targets Tg in the images captured by a pair of the imaging devices 30c and 30d mounted to be directed downward.

For this example, the targets Tg may only be mounted to the working unit 2 using the mounting fixture 60 in the external calibration and the vehicle calibration, and thus the targets Tg do not need to be placed outside the excavator 100. Thus, preparation of the external calibration and the vehicle calibration can be simplified.

<Place for Calibration>

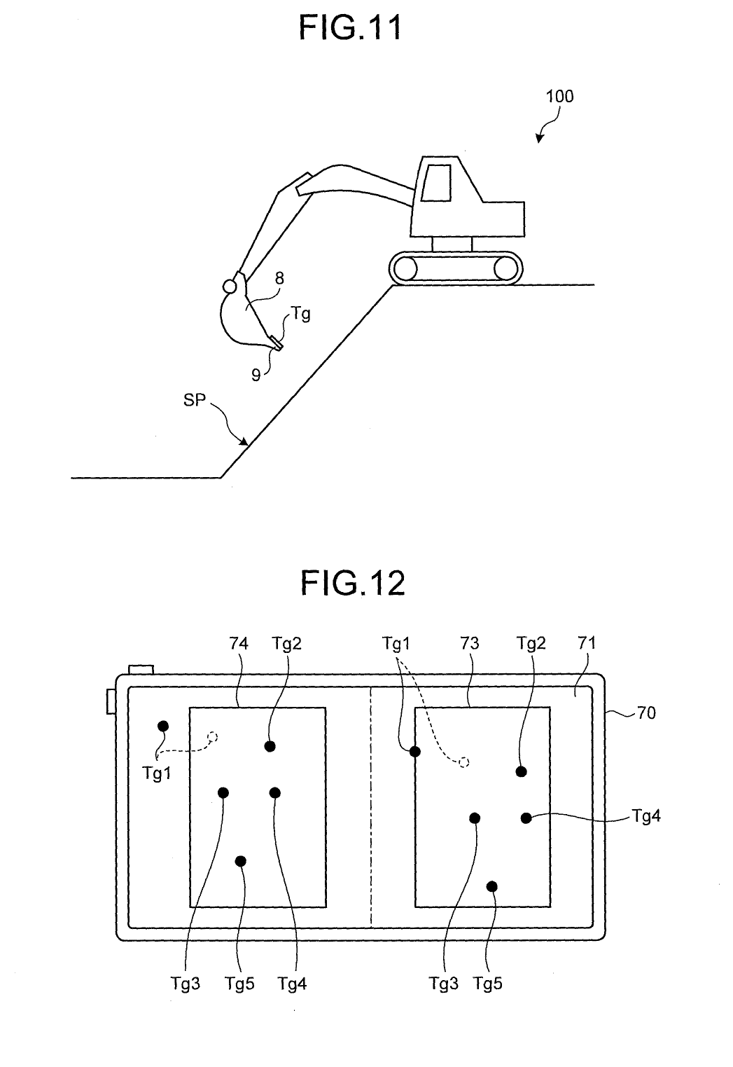

FIG. 11 is a diagram illustrating a place where at least a pair of imaging devices 30 is calibrated. As illustrated in FIG. 11, the excavator 100 is placed in front of an inclined surface SP which is reduced in height with receding from the excavator 100. While the excavator 100 is placed at a position where such an inclined surface SP is in front of the excavator 100, at least a pair of the imaging devices 30 may be calibrated.

In the calibration according to an embodiment, the processing unit 21 causes a pair of the imaging devices 30a and 30b and a pair of the imaging devices 30c and 30d to image the targets Tg mounted to the teeth 9 of the bucket 8 in the working unit 2 in different attitudes. In this configuration, moving the bucket 8 up and down over the inclined surface SP brings about a working range of the bucket 8, which extends below a surface on which the excavator 100 is placed. Thus, when the bucket 8 is positioned in a range below the surface on which the excavator 100 is placed, a pair of the imaging devices 30c and 30d mounted to be directed downward can image the targets Tg mounted to the teeth 9 of the bucket 8. Thus, the rate of the targets Tg in the images captured by a pair of the imaging devices 30c and 30d mounted to be directed downward can be maintained.

<Example of Tool Used for Preparation of Calibration>

FIG. 12 is a diagram illustrating an example of a tool used for placing a target Tg outside an excavator 100. To place the target Tg, for example a portable terminal device 70 including a display unit for displaying a guidance for the target Tg on a screen 71 may be used as an auxiliary tool for placing the target. In this example, the portable terminal device 70 obtains images captured by a pair of imaging devices 30 to be calibrated from the processing device 20 of the excavator 100. Then, the portable terminal device 70 displays the images captured by the imaging devices 30 on the screen 71 of the display unit, together with guide frames 73 and 74.

The guide frames 73 and 74 represent ranges used for the stereo matching in a pair of the images captured by a pair of the imaging devices 30. In the stereo matching, a pair of the images captured by a pair of the imaging devices 30 are searched for corresponding portions. A pair of the imaging devices 30 have different imaging ranges, and a common portion of the ranges imaged by a pair of the imaging devices 30 is an object to be searched, that is, a range used for the stereo matching (three-dimensional measurement). The guide frames 73 and 74 are images representing the common portion of the ranges imaged by a pair of the imaging devices 30.

In an example illustrated in FIG. 12, an image captured by one imaging device 30 is displayed on the left side of the screen 71, and an image captured by the other imaging device 30 is displayed on the right side of the screen 71. Each of the images displays five targets Tg1, Tg2, Tg3, Tg4, and Tg5. All of the targets Tg1, Tg2, Tg3, Tg4, and Tg5 are positioned inside the guide frame 73, but the target Tg1 is outside the guide frame 74. In this condition, the target Tg is not used for the calibration, and precision in calibration cannot be maintained. Thus, the worker performing calibration adjusts the position of the target Tg5 while visually confirming the screen 71 of the portable terminal device 70 so that the target Tg5 is positioned inside the guide frame 74.

On the screen 71, movement of the target Tg5 is displayed, and the worker performing calibration can dispose a large number of targets Tg in the range used for the stereo matching for a pair of the imaging devices 30, and can dispose the targets Tg all over the range described above. Consequently, precision in calibration according to an embodiment is increased. The guide frames 73 and 74 and the images captured by a pair of the imaging devices 30 are displayed on the screen of the portable terminal device 70, so that the worker performing calibration can confirm a result while placing the targets Tg, and working efficiency in placing the targets Tg is increased.

In this example, a pair of images captured by a pair of the imaging devices 30 are displayed on the screen 71 of the display unit of the portable terminal device 70, but a total of four images captured by a pair of the imaging devices 30a and 30b and a pair of the imaging devices 30c and 30d of the excavator 100 may be displayed on the screen 71. The above-mentioned configuration allows the worker performing calibration to place the targets Tg, while considering balance in disposition of the targets Tg, between the images captured by all the imaging devices 30a, 30b, 30c, and 30d of the excavator 100.

The guide frames 73 and 74 and the images captured by a pair of the imaging devices 30 may be displayed on a screen other than the screen 71 of the portable terminal device 70. For example, the guide frames 73 and 74 and the images captured by a pair of the imaging devices 30 may be displayed on the monitor panel 26 provided in the cab 4 of the excavator 100. Such a configuration eliminates the need for the portable terminal device 70.

As described above, in the calibration system 50 and the calibration method according to an embodiment, the predetermined position of the working unit 2 is imaged by at least a pair of imaging devices 30, the first position information about the predetermined position of the working unit 2 is determined from the obtained images, the second position information about the predetermined position in imaging is determined by the position detection device different from at least a pair of the imaging devices 30, the predetermined positions outside the work machine are imaged by at least a pair of the imaging devices 30, and the third position information about the predetermined positions outside the work machine is determined from the obtained images. In the calibration system 50 and the calibration method according to an embodiment, the first position information, the second position information, and the third position information are used to determine the information about the positions and the attitudes of at least a pair of the imaging devices 30, and the transformation information used for transforming the position of an object imaged by at least a pair of the imaging devices 30 from the first coordinate system to the second coordinate system. Owing to such processing, the calibration system 50 and the calibration method according to an embodiment can simultaneously perform the external calibration and the vehicle calibration of at least a pair of the imaging devices 30 mounted to the work machine. Furthermore, in the calibration system 50 and the calibration method according to an embodiment, the predetermined position of the working unit 2 and the predetermined positions outside the work machine can be imaged by at least a pair of the imaging devices 30 to obtain the information required for the calibration, and thus, at least a pair of the imaging devices 30 can be calibrated, even in the site on which the work machine works and where preparation of the calibration instrument, man power for operating the calibration instrument, the dedicated facility, and the like is difficult.

In the calibration system 50 and the calibration method according to an embodiment, the targets Tg are placed outside the work machine in addition to the targets Tg mounted to the working unit 2, and thus, the targets Tg can be scattered in a wide range of the images captured by at least a pair of the imaging devices 30. Consequently, precision in stereoscopic three-dimensional measurement can be increased in a wide range of the object to be imaged by at least a pair of the imaging devices 30. Furthermore, the targets Tg placed outside the work machine maintains the rate of the targets Tg in the images captured by a pair of the imaging devices 30c and 30s mounted to be directed downward can be inhibited. Consequently, the ground is accurately subjected to the stereoscopic three-dimensional measurement, and precision in measurement can be increased.

In the embodiment, the second position information employs information about the center position of the working unit in a direction in which at least a pair of the imaging devices 30 are disposed, so that precision in vehicle calibration can be maintained. In the embodiment, the second position information preferably employs a plurality of kinds of information obtained from the working unit 2 in at least three different attitudes. In the embodiment, two pairs of imaging devices 30 are calibrated, but the calibration system 50 and the calibration method according to an embodiment can also be applied to calibration of a pair of imaging devices 30 and calibration of at least three pairs of imaging devices 30.

In the embodiment, the position detection device includes the first angle detection unit 18A, the second angle detection unit 18B, and the third angle detection unit 18C, but the position detection device is not limited to them. For example, the excavator 100 can include a real time kinematic-global navigation satellite systems (RTK-GNSS, GNSS represents global navigation satellite system) antenna, and a position detection system for measuring a position of the antenna using GNSS to detect a position of the excavator. In this configuration, the above-mentioned position detection system is used as a position detection device, and the position of the GNSS antenna is defined as the predetermined position of the work machine. Then, at least a pair of imaging devices 30 and the position detection device detect the position of the GNSS antenna while changing the position of the GNSS antenna, and the first position information and the second position information can be obtained. The processing unit 21 uses he obtained first position information and second position information, and the third position information obtained from the targets Tg placed outside the work machine to determine the position information, the attitude information, and the transformation information.

In addition to this, a removable GNSS receiver can be mounted to a predetermined position of the excavator 100, for example, a predetermined position of the travel body 5 or the working unit 2, to use the GNSS receiver as the position detection device, and the transformation information can be obtained similarly to the above-mentioned position detection system for detecting the position of the excavator, used as the position detection device.

As long as the work machine includes at least a pair of imaging devices 30, and uses at least a pair of the imaging devices 30 to perform the stereoscopic three-dimensional measurement on the object, the work machine is not limited to the excavator 100. The work machine preferably has the working unit, and the work machine may be for example a wheel loder or a bulldozer.

In the embodiment, the targets Tg are provided at the teeth 9 to determine the position information, the attitude information, and the transformation information, but the targets Tg are not necessarily employed. For example, the input device 52 illustrated in FIG. 4 may specify a portion for positional determination by the processing unit 21, for example, a portion of a tooth 9 of the bucket 8, in the image of the object captured by at least a pair of imaging devices 30.

The embodiment has been made as described above, but the embodiment is not limited to the above-mentioned contents. Furthermore, the above-mentioned components include a component conceived by those skilled in the art, a substantially identical component, and a so-called equivalent component. The above-mentioned components can be appropriately combined with each other. At least one of various omission, substitution, and alteration of the components may be made without departing from the spirit of the invention.

### REFERENCE SIGNS LIST

1 VEHICLE BODY
2 WORKING UNIT
3 SWING BODY
3T FRONT END
4 CAB
5 TRAVEL BODY
6 BOOM
7 ARM
8 BUCKET
9, 9L, 9C, 9R TOOTH
10 BOOM CYLINDER
11 ARM CYLINDER
12 BUCKET CYLINDER
18A FIRST ANGLE DETECTION UNIT
18B SECOND ANGLE DETECTION UNIT
18C THIRD ANGLE DETECTION UNIT
20 PROCESSING DEVICE
21 STORAGE UNIT
21 PROCESSING UNIT
22 STORAGE UNIT
23 INPUT/OUTPUT UNIT
30, 30a, 30b, 30c, 30d IMAGING DEVICE
50 CALIBRATION SYSTEM
100 EXCAVATOR
Tg, Tg1, Tg2, Tg3, Tg4, Tg5, Tgl, Tgc, Tgr TARGET

1. A calibration system comprising:
at least a pair of imaging devices included in a work machine having a working unit that image an object;
a position detection device that detects a position of the working unit; and
a processing unit that, by using first position information being information about a predetermined position of the working unit captured by at least the pair of the imaging devices, second position information being information about the predetermined position detected by the position detection device in an attitude of the working unit taken when at least the pair of the imaging devices image the predetermined position, and third position information being information about a predetermined position outside the work machine, imaged by at least the pair of the imaging devices, obtains information about a position and an attitude of at least the pair of the imaging devices, and transformation information used for transforming a position of the object imaged by at least the pair of the imaging devices from a first coordinate system to a second coordinate system.

2. The calibration system according to claim 1, wherein
a first indicator is disposed at the predetermined position of the working unit, and the first position information is information obtained by imaging positions of the first indicator in the working unit in different attitudes by at least the pair of the imaging devices,
the second position information is information obtained by detecting the predetermined position based on the working unit in different attitudes by the position detection device, and
the third position information is information about a position of a second indicator placed outside the work machine.

3. The calibration system according to claim 1, wherein
the second position information is information about a center position of the working unit in a direction in which at least the pair of the imaging devices are disposed, and a plurality of information obtained from the working unit in at least three different attitudes.

4. The calibration system according to claim 1, wherein
the position detection device is a sensor included in the work machine to detect an amount of movement of an actuator that actuates the working unit.

5. A work machine comprising:
the working unit; and
the calibration system according to claim 1.

6. A calibration method comprising:
imaging a predetermined position of a working unit and a predetermined position around a work machine having the working unit by at least a pair of imaging devices, and detecting a predetermined position of the work machine by a position detection device different from at least the pair of the imaging devices; and
obtaining information about a position and an attitude of at least the pair of the imaging devices, and transformation information used for transforming a position of the object detected by at least the pair of the imaging devices from a first coordinate system to a second coordinate system, by using first position information being information about a predetermined position of the working unit captured by at least the pair of the imaging devices, second position information being information about the predetermined position detected by the position detection device in an attitude of the working unit taken when at least the pair of the imaging devices image the predetermined position, and third position information being information about a predetermined position outside the work machine, imaged by at least the pair of the imaging devices.
